(19) United States
(12) Patent Application Publication
(10) Pub. No.: US 2025/0104421 A1
(43) Pub. Date: Mar. 27, 2025

(54) INFORMATION PROCESSING APPARATUS, DISPLAY CONTROL METHOD, AND STORAGE MEDIUM

(71) Applicant: NEC Corporation, Minato-ku, Tokyo (JP)

(72) Inventors: Yuko OHTA, Tokyo (JP); Shin NORIEDA, Tokyo (JP); Shogo AKASAKI, Tokyo (JP); Akihiro NAKAMURA, Tokyo (JP); Takeshi NAGATO, Tokyo (JP); Yukiko TABUCHI, Tokyo (JP); Koki KITAGUCHI, Tokyo (JP)

(73) Assignee: NEC Corporation, Minato-ku, Tokyo (JP)

(21) Appl. No.: 18/832,136

(22) PCT Filed: Mar. 29, 2022
(86) PCT No.: PCT/JP2022/015674

§ 371 Date: Jul. 23, 2024

(51) Int. Cl. G06V 20/20; G06T 7/11; G06T 7/73; G06T 7/90; G06T 11/00; G06V 20/68

(52) U.S. Cl. CPC G06V 20/20; G06T 7/11; G06T 7/74; G06T 7/90; G06T 11/001; G06V 20/68; G06T 2207/10024; G06T 2207/20104; G06T 2207/30196; G06T 2207/30204

(57) ABSTRACT

To perform overlay display of information related to a food item in an appropriate position, an information processing apparatus (1) includes: a detection section (101) that detects a predetermined detection target in an image that is obtained by capturing at least part of a field of view of a user and shows a food item; an overlay area setting section (102) that sets, in the image, an overlay area for information related to the food item by using the detection target as a reference; and a display control section (103) that performs overlay display of the information on the overlay area.

### TECHNICAL FIELD

The present invention relates to augmented reality (AR) technology for performing overlay display of information on images obtained by capturing at least part of user's fields of view.

### BACKGROUND ART

The use of the AR technology has been studied in various applications. For example, Patent Literature 1 below discloses a head-mounted display (HMD) utilizing the AR technology to manage a calorific intake. The HMD of Patent Literature 1 display a view overlaying a blue filter on food when an acceptable calorific intake remaining for a user who is wearing the HMD becomes less than or equal to a specific value. With this processing, the HMD of Patent Literature 1 makes the user's appetite reduced when the acceptable calorific intake is less than or equal to the specific value, to control the calorific intake of the user.

### CITATION LIST

### Patent Literature

Patent Literature 1
Japanese Patent Application Publication Tokukai No. 2020-042401

### SUMMARY OF INVENTION

### Technical Problem

Since the blue filter displayed in an overlaid fashion on a food item shown through the HMD disclosed in Patent Literature 1 is employed to reduce the user's appetite, it is sufficient that the display position of the blue filter roughly coincide with the position of the food item shown through the HMD. Thus, Patent Literature 1 does not specifically describe a configuration for performing overlay display of information related to the food item in an appropriate position.

An example aspect of the present invention has been made in view of this point, and an example object thereof is to provide a technique capable of performing overlay display of information related to a food item in an appropriate position.

### Solution to Problem

An information processing apparatus in accordance with an example aspect of the present invention includes: detection means for detecting a predetermined detection target in an image that is obtained by capturing at least part of a field of view of a user and shows a food item; overlay area setting means for setting, in the image, an overlay area for information related to the food item by using the detection target as a reference; and display control means for performing overlay display of the information on the overlay area.

A display control method in accordance with an example aspect of the present invention includes: detecting, by at least one processor, a predetermined detection target in an image that is obtained by capturing at least part of a field of view of a user and shows a food item; setting, by the at least one processor, in the image, an overlay area for information related to the food item by using the detection target as a reference; and performing, by the at least one processor, overlay display of the information on the overlay area.

A display control program in accordance with an example aspect of the present invention causes a computer to function as: detection means for detecting a predetermined detection target in an image that is obtained by capturing at least part of a field of view of a user and shows a food item; overlay area setting means for setting, in the image, an overlay area for information related to the food item by using the detection target as a reference; and display control means for performing overlay display of the information on the overlay area.

### Advantageous Effects of Invention

According to an example aspect of the present invention, it is possible to perform overlay display of information related to a food item in an appropriate position.

### BRIEF DESCRIPTION OF DRAWINGS

FIG. 1 is a block diagram illustrating the configuration of an information processing apparatus in accordance with a first example embodiment of the present invention.

FIG. 2 is a flowchart illustrating the flow of a display control method in accordance with the first example embodiment of the present invention.

FIG. 3 is a diagram illustrating an example of use of the information processing apparatus in accordance with the second example embodiment of the present invention.

FIG. 4 is a block diagram illustrating an example of the configuration of the main part of the information processing apparatus.

FIG. 5 is a diagram illustrating a setting example of an overlay area of the information processing apparatus.

FIG. 6 is a diagram illustrating a generation example of an overlay image of the information processing apparatus.

FIG. 7 is a flowchart illustrating the flow of a display control method in accordance with a second example embodiment of the present invention.

FIG. 8 is a diagram illustrating an example in which multiple food areas are set in an overlay area and overlay display is performed.

FIG. 9 is a diagram illustrating an example in which an overlay image is displayed by using chopsticks held by the user as a detection target.

FIG. 10 is a diagram illustrating a setting example of an overlay area in which a fork is used as a detection target, and a setting example of an overlay area in which a user's hand holding a fork is used as a detection target.

FIG. 11 is a diagram illustrating an example of a computer that executes instructions of a program which is software implementing the functions of the apparatuses in accordance with the example embodiments of the present invention.

### EXAMPLE EMBODIMENTS

### First Example Embodiment

A first example embodiment of the present invention will be described in detail with reference to the drawings. The present example embodiment is a basic form of example embodiments described later.

### Configuration of Information Processing Apparatus 1

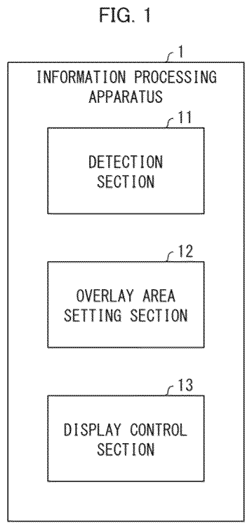

The following description will discuss the configuration of an information processing apparatus 1 in accordance with the present example embodiment with reference to FIG. 1. FIG. 1 is a block diagram illustrating the configuration of the information processing apparatus 1. As illustrated in FIG. 1, the information processing apparatus 1 includes a detection section (detection means) 11, an overlay area setting section (overlay area setting means) 12, and a display control section (display control means) 13.

The detection section 11 detects a predetermined detection target in an image that is obtained by capturing at least part of a field of view of a user and shows a food item.

The overlay area setting section 12 sets, in the image, an overlay area for information related to the food item by using the detection target detected by the detection section 11 as a reference.

The display control section 13 performs overlay display of the information on the overlay area set by the overlay area setting section 12.

As described in the foregoing, the information processing apparatus 1 in accordance with the present embodiment employs a configuration including: the detection section 11 that detects a predetermined detection target in an image that is obtained by capturing at least part of a field of view of a user and shows a food item; the overlay area setting section 12 that sets, in the image, an overlay area for information related to the food item by using the detection target as a reference; and the display control section 13 that performs overlay display of the information on the overlay area. Thus, the information processing apparatus 1 in accordance with the present example embodiment achieves an example advantage of being capable of performing overlay display of the information related to the food item in an appropriate position.

### Display Control Program

The abovementioned functions of the information processing apparatus 1 may be implemented by a program. The display control program in accordance with the present example embodiment causes a computer to function as the detection section 11, the overlay area setting section 12, and the display control section 13. This display control program achieves an example advantage of being capable of performing overlay display of the information related to the food item in an appropriate position.

### Flow of Display Control Method

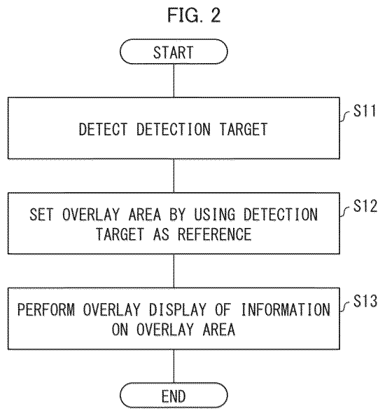

The following description will discuss the flow of a display control method in accordance with the present example embodiment with reference to FIG. 2. FIG. 2 is a flowchart illustrating the flow of the display control method. It should be noted that steps of the display control method may be carried out by a processor of the information processing apparatus 1 or by a processor of another apparatus. Alternatively, the steps may be carried out by processors provided in respective different apparatuses.

In S11, at least one processor detects a predetermined detection target in an image that is obtained by capturing at least part of a field of view of a user and shows a food item.

In S12, the at least one processor sets, in the image, an overlay area for information related to the food item by using the detection target detected in S11 as a reference.

In S13, the at least one processor performs overlay display of the information on the overlay area set in S12.

As described in the foregoing, the display control method in accordance with the present example embodiment includes: detecting, by at least one processor, a predetermined detection target in an image that is obtained by capturing at least part of a field of view of a user and shows a food item; setting, by the at least one processor, in the image, an overlay area for information related to the food item by using the detection target as a reference; and performing, by the at least one processor, overlay display of the information on the overlay area. This display control method achieves an example advantage of being capable of performing overlay display of the information related to the food item in an appropriate position.

### Second Example Embodiment

### Outline

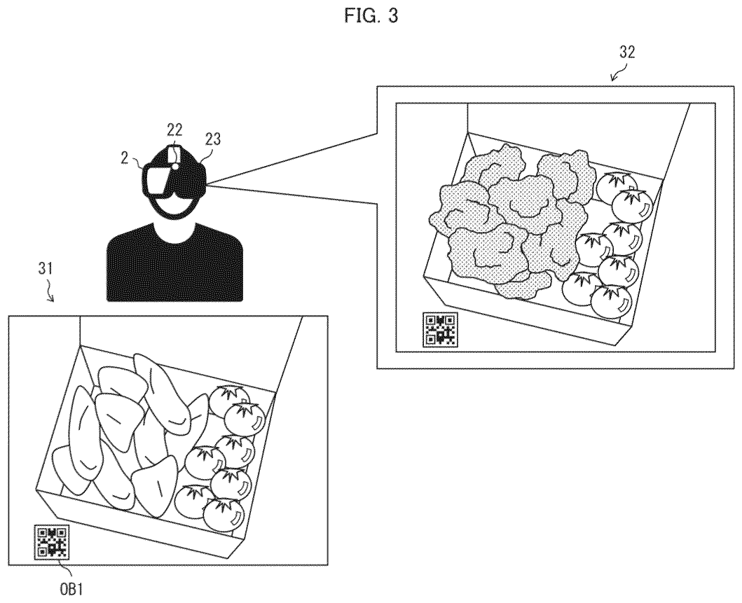

The following description will discuss the outline of an information processing apparatus 2 in accordance with the present example embodiment with reference to FIG. 3. FIG. 3 is a diagram illustrating an example of use of the information processing apparatus 2. As illustrated in the figure, the information processing apparatus 2 is a head-mounted display adapted to be worn on the head of a user. The information processing apparatus 2 is configured to display so-called augmented reality (AR) contents.

Thus, the information processing apparatus 2 includes: a capturing section 22 that captures at least part of a field of view of the user who is wearing the information processing apparatus 2; and a display section 23 that displays an image captured by the capturing section 22. By performing overlay display of the AR contents on an image captured by the capturing section 22, the information processing apparatus 2 allows the user to experience an augmented reality.

When displaying the AR contents, the information processing apparatus 2 detects a predetermined detection target in an image 31 that is obtained by capturing at least part of a field of view of the user and shows a food item. In the example of FIG. 3, the information processing apparatus 2 detects a three-dimensional code OB1 provided on a table on which a lunchbox is placed. Herein, the term “food item” may be anything that can be ingested by a user, and the category of the “food item” may include, for example, something made of a single ingredient, such as fruits, and something made by using multiple ingredients, such as meals, supplements, pharmaceuticals, and beverages, etc.

The information processing apparatus 2 sets, by using the detected three-dimensional code OB1 as a reference, an overlay area in the image captured by the capturing section 22, and performs overlay display of information related to the food item on the set overlay area. An image 32 illustrated in FIG. 3 is obtained by setting, in the image 31, an area showing pieces of cooked chicken breast (steamed chicken) as an overlay area, and performing overlay display of an image of pieces of deep-fried chicken on the overlay area.

This causes the user who is wearing the information processing apparatus 2 to see as if there were the high-calorie deep-fried chicken instead of the low-calorie chicken breast. Thus, the user can feel satisfaction as if the user had eaten deep-fried chicken while reducing calorie intake by actually eating cooked chicken breast. Further, since the information processing apparatus 2 sets the overlay area by using the detected three-dimensional code OB1 as a reference, it is possible to perform overlay display of the information related to the food item (in the example of FIG. 3, the image of pieces of deep-fried chicken) in an appropriate position.

It should be noted that the information processing apparatus 2 is not limited to the head-mounted display, but may be, for example, a smartphone or the like. When a smartphone is employed for the information processing apparatus 2, a fastening mount for fastening the display of the smartphone in front of the user's eyes may be used. For example, as the information processing apparatus 2, an eyeglasses- or goggles-type display apparatus may be employed.

### Configuration of Information Processing Apparatus 2

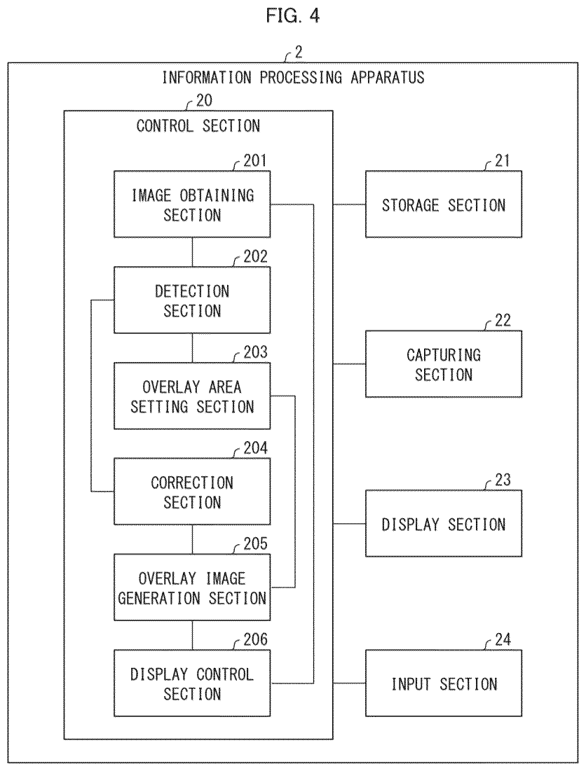

The following description will discuss the configuration of the information processing apparatus 2 with reference to FIG. 4. FIG. 4 is a block diagram illustrating the configuration of the information processing apparatus 2. As illustrated in the figure, the information processing apparatus 2 includes: a control section 20 that centrally controls each section of the information processing apparatus 2; and a storage section 21 that stores various data used by the information processing apparatus 2.

The information processing apparatus 2 also includes the capturing section 22 that captures an image, the display section 23 that displays the image, and an input section 24 that receives an input operation to the information processing apparatus 2. It should be noted that, for example, the information processing apparatus 2 may be an apparatus that operates by sensing the user's gaze and by receiving as input the direction and the movement of the gaze; in this case, the input section 24 may be omitted.

The control section 20 includes an image obtaining section 201, a detection section (detection means) 202, an overlay area setting section (overlay area setting means) 203, a correction section (correction means) 204, an overlay image generation section 205, and a display control section (display control means) 206.

The image obtaining section 201 obtains an image obtained by capturing at least part of a field of view of the user. The capturing section 22 is disposed so as to capture in a direction of the gaze of the user who is wearing the information processing apparatus 2, so that the image captured by the capturing section 22 is an image obtained by capturing at least part of a field of view of the user. Thus, the image obtaining section 201 obtains an image captured by the capturing section 22. For example, the image obtaining section 201 may obtain an image by extracting time-series frame images from moving images captured by the capturing section 22.

The detection section 202 detects a predetermined detection target in the image obtained by the image obtaining section 201. The predetermined detection target is used as a reference in setting, in the image obtained by the image obtaining section 201, an overlay area for information related to a food item shown in the image. For example, in the example of FIG. 3, the three-dimensional code OB1 is the predetermined detection target. Of course, the predetermined detection target may be any object that is capable of serving as a reference in setting an overlay area, and is not limited to the three-dimensional code OB1.

The detection section 202 also detects a color correction marker, serving as a reference of color correction, in the image obtained by the image obtaining section 201. Details of the color correction marker will be described under the item “Color correction”. Here, a process block for detecting the color correction marker may be provided separately from the detection section 202.

The overlay area setting section 203 sets, in the image obtained by the image obtaining section 201, an overlay area for information related to the food item by using the abovementioned detection target detected by the detection section 202 as a reference. A specific method of setting the overlay area will be described under the item “Setting method of overlay area”.

The correction section 204 subjects the image obtained by the image obtaining section 201 to color correction by means of the abovementioned color correction marker detected by the detection section 202. The method of performing color correction will be described below under the item “Color correction”.

The overlay image generation section 205 generates an overlay image to be overlaid on the image obtained by the image obtaining section 201. The overlay image may be any image that includes information related to the food item. For example, the overlay image generation section 205 may generate an image of a predetermined food item as in the example of FIG. 3 as the overlay image, or alternatively, may generate an overlay image including attribute information of a food item such as nutrients and calories the food item has. The overlay image generation section 205 may generate an image of any character (e.g., character based on user's preferences) as the overlay image. Such a character may be one displayed as a still image, or may be one displayed as moving images. These images may be two-dimensional or three-dimensional. For example, the overlay image may be an image of any virtual character of an animated cartoon or a manga, or an image of any real person (including any famous person). An original image from which the overlay image is generated (e.g., texture images of various food items or images of characters) may be stored in, for example, the storage section 21. A method of generating the overlay image will be described under the item “Generation method of overlay image”.

The display control section 206 performs overlay display of information related to the food item on the overlay area set by the overlay area setting section 203. Specifically, the display control section 206 composites the overlay image generated by the overlay image generation section 205 on the overlay area set by the overlay area setting section 203, and displays the composite image, to perform overlay display of the information related to the food item.

As described in the foregoing, the information processing apparatus 2 in accordance with the present example embodiment includes: the detection section 202 that detects a predetermined detection target in an image that is obtained by capturing at least part of a field of view of a user and shows a food item; the overlay area setting section 203 that sets, in the image, an overlay area for information related to the food item by using the detection target as a reference; and the display control section 206 that performs overlay display of the information on the overlay area. Thus, the information processing apparatus 2 in accordance with the present example embodiment achieves an example advantage of being capable of performing overlay display of the information related to the food item in an appropriate position.

Further, as described above, in the information processing apparatus 2 in accordance with the present example embodiment, the display control section 206 may perform overlay display of an image of a predetermined food item on the overlay area. Thus, in addition to the example advantage achieved by the information processing apparatus 1 in accordance with the first example embodiment, it is possible to achieve an example advantage of being capable of increasing the satisfaction of a meal.

Here, the predetermined food item may be a food item different from that shown in the original image, or may be the same food item. When an image of the same food item is displayed, the amount of the food item may differ from that of the food item shown in the original image. Performing overlay display of an image showing a larger amount of the food item enables the user to feel that he/she have eaten more food than he/she actually had, so that it is possible to increase the satisfaction of the meal. This may be effective for, for example, a user during weight reduction or the like. Further, performing overlay display of an image showing a smaller amount of the food item enables the user to feel that the amount of food is less than it actually is, to urge the user to intake a required amount of food. This may be effective for, for example, a user who does not eat much.

### Setting Method of Overlay Area

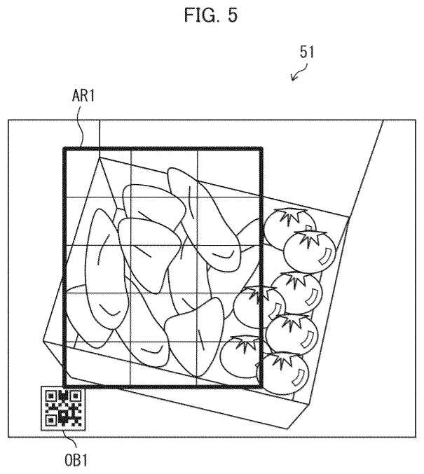

The following description will discuss a setting method of the overlay area carried out by the overlay area setting section 203, with reference to FIG. 5. FIG. 5 is a diagram illustrating a setting example of the overlay area. In the example of FIG. 5, the overlay area setting section 203 sets, in an image 51 captured by the capturing section 22, an overlay area AR1 by using a three-dimensional code OB1 as a reference.

The three-dimensional code OB1 is provided on the table on which the lunchbox is placed. The three-dimensional code OB1 indicates the position and the area of cooked chicken breast packed in the lunchbox. More particularly, the three-dimensional code OB1 includes information indicating the position of the three-dimensional code OB1 in the three-dimensional space, and the position and the area of the cooked chicken breast (area in which the cooked chicken breast is shown). The information may be represented by, for example, three-dimensional space coordinates.

The overlay area setting section 203 may determine the position and the area in which the cooked chicken breast is shown in the image 51, based on the abovementioned information included in the three-dimensional code OB1, and set an overlay area in the position and the area. For example, the abovementioned information included in the three-dimensional code OB1 may indicate three-dimensional coordinate values of the four corners of a rectangle indicating the position and the area of the cooked chicken breast. In this case, the overlay area setting section 203 can determine the position and the area in which the cooked chicken breast is shown in the image 51 by converting the coordinate values into coordinate values on the image 51. It should be noted that the lunchbox needs to be placed at a predetermined position with respect to the three-dimensional code OB1. The three-dimensional code OB1 may also include information indicating information related to the food item (e.g., the name of the meal, used ingredient(s), or the like), information indicating an image to be subjected to overlay display on the food item, or the like.

Further, any other type of code such as a two-dimensional code may be used to set an overlay area in a similar manner. An item on which the code is provided only needs to be an item that has a predetermined positional relationship with the food item. For example, the code may be provided on an item placed on a table, such as a tablecloth, or alternatively, a container or a tableware item for accommodating food.

Here, for example, some restaurant or the like may provide an extensive menu and there may be a need to vary the overlay area depending on the type of meals. Thus, for example, the overlay area setting section 203 may obtain order information indicating an ordered meal and set an overlay area in a position and an area according to the ordered meal. In this case, a table or an item placed on the table such as a tablecloth may be provided with a code, and a meal ordered may be served at a predetermined position with respect to the code.

As described in the foregoing, the detection target serving as a reference for setting the overlay area may be a code that is provided on an item having a predetermined positional relationship with the food item, and indicates the position and the area of the food item. In this case, the overlay area setting section 203 sets the overlay area based on the position and the area indicated by the code. Accordingly, in addition to the example advantage achieved by the information processing apparatus 1 according to the first example embodiment, it is possible to achieve an example advantage of being capable of setting the overlay area with high accuracy.

Here, the overlay area does not necessarily need to be set in an area where a food item is shown. For example, when information related to a food item such as calorie of the food item is displayed or when a character image is displayed, the overlay area setting section 203 may set an overlay area outside an area where the food item is shown. For example, the overlay area setting section 203 may set an overlay area along the outer periphery of the position and area indicated by the code outside the area. This allows the information related to the food item to be displayed along the outer periphery of the food item. Here, as described above, the character may be one displayed as a still image or may be one displayed as moving images. These images may be two-dimensional or three-dimensional. For example, an image of any virtual character of an animated cartoon or a manga may be used in overlay display, or an image of any real person (including any famous person) may be used in overlay display.

### Food Area Determination

Here, the overlay area ARI illustrated in FIG. 5 includes a space in which no chicken breast is shown. If an image of another food item (e.g., image of deep-fried chicken as illustrated in FIG. 3) is subjected to overlay display on such a space, it might appear as if the food item were present at the position where no food item were actually present.

Thus, when overlaying, on a food item, an image of another food item, the overlay image generation section 205 may first determine a food area in which the food item is shown in the overlay area AR1, and next, the overlay image generation section 205 may generate an overlay image according to the shape and size of the determined food area.

For example, in the example of FIG. 5, the overlay area AR1 is divided into 15 sections of 5×3 in height and width. Of these sections, a section located at the lower left end shows almost no cooked chicken breast. Thus, the overlay image generation section 205 may determine, from among the sections, a section or sections in which the food item is captured as a food area, and determine, as a non-overlay area, a section or sections in which no food item is shown or in which the rate of the area the food item is shown made up in its section is not more than a threshold value. This makes it possible to allow the overlay display to be performed only on the food area in the overlay area, instead of the entirety of the overlay area.

It should be noted that any determination method of a food area may be employed; for example, if the color of the food item is known, the overlay image generation section 205 may determine a food area based on the color (specifically, pixel values). Further, for example, the overlay image generation section 205 may detect, in the image 51, an edge that is a portion in which the pixel values change sharply, and determine an area on a higher pixel value side or a lower pixel value side with respect to the edge as a food area.

In a case where a food area is determined based on the color, the color range of the food item may be determined in advance. In this regard, there may be a case where the same food items appear in different colors due to, for example, how light strikes the food items. Therefore, two or more color ranges may be set for one food item. In this case, the overlay image generation section 205 sets an area including pixels within the respective color ranges as a food area.

### Generation Method of Overlay Image and Color Correction

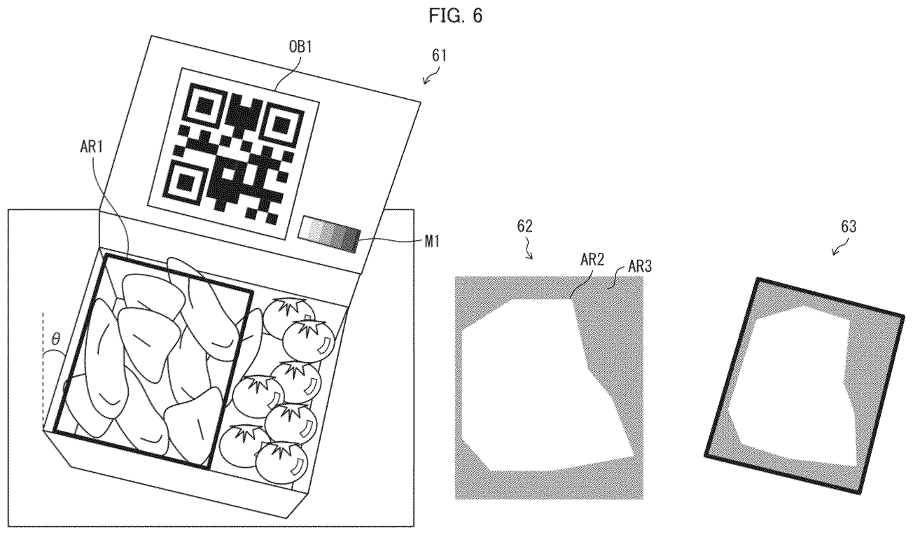

The following description will discuss a generation method of an overlay image carried out by the overlay image generation section 205, with reference to FIG. 6. FIG. 6 is a diagram illustrating a generation example of an overlay image. The following description will also discuss color correction performed by the correction section 204.

An image 61 illustrated in FIG. 6 is an image captured by the capturing section 22, and the image 61 shows a lunchbox with a lid containing cooked chicken breast. As illustrated in the figure, on the inner side of the lid of the lunchbox (the side exposed when the lid is opened), provided is a three-dimensional code OB1 and a color correction marker M1. Thus, the detection target (the three-dimensional code OB1 in this example) serving as a reference for setting an overlay area may be provided on a container for accommodating a food item. In this case, it is desirable that the detection target be provided in a position that is parallel to the table surface on which the lunchbox is placed.

### Color Correction

As described above, determining a food area makes it possible to perform overlay display according to the shape of the food area; however, the determination accuracy of the food area may be reduced due to an effect caused by conditions under which capturing has taken place, such as a lighting environment. For example, when an area having pixel values that are not less than a predetermined threshold is determined as a food area, there is a concern that, in a case where the surroundings of a food item is dark, there is a possibility that an area narrower than the actual area in which a food item is shown will be determined as a food area.

Thus, the correction section 204 subjects the image 61 to color correction by means of the color correction marker M1 that is detected in the image 61 and serves as a reference of the color correction. Then, the display control section 206 performs overlay display of the image of the predetermined food item on the area having a predetermined color range in the overlay area undergone the color correction. In this way, the effect caused by the capturing conditions of the image 61 can be cancelled, so that it is possible to achieve an example advantage of being capable of stably performing overlay display on a reasonable position and area regardless of capturing conditions, in addition to the example advantage achieved by the information processing apparatus 1 in accordance with the first example embodiment.

The color correction is performed such that the pixel value(s) in the color correction marker M1 part become a predetermined value(s). For example, the color correction marker M1 illustrated in FIG. 6 includes a plurality of color samples. More particularly, the left end of the color correction marker M1 is a color sample for white, the right end is a color sample for black, and a plurality of color samples for gray colors are arranged between these white and black samples (as righter the sample is located, the blacker a grey color is). It should be noted that the color correction marker M1 only needs to include at least one color sample.

For example, it is assumed that the pixel value (RGB value) of the white color sample area in the image 61 is (230, 216, 231). In this case, the correction section 204, for example, corrects for the image 61 such that the pixel value of the pixel becomes a predetermined value (e.g., (239, 239, 239)). In this way, it is possible to determine the food area while canceling the effect caused by the capturing conditions of the image 61. The predetermined value may be determined in advance.

Here, instead of performing the color correction to the image 61, the correction section 204 may correct for a threshold for use in determination of a food area by means of the color correction marker M1. For example, when the pixel value of the color sample of the color correction marker M1 shown in the image 61 is greater than a reference value, the correction section 204 may also correct for the threshold to a value greater than the reference value. The same applies when the pixel value of the color sample is less than the reference value. For example, when correcting for the threshold for the color image 61, the correction section 204 may correct for the threshold for each of the R, G, and B values. Further, the correction amount of the threshold may be determined according to the difference between the pixel value of the color sample and the reference value. Such correction can also cancel the effect caused by the capturing conditions of the image 61.

Multiple correction patterns may be prepared in advance according to the capturing conditions. In this case, the correction section 204 may correct for the image 61 by applying a correction pattern corresponding to the capturing conditions at the time of capturing of the image 61. Similarly, among the multiple thresholds corresponding to the capturing conditions, a threshold corresponding to the capturing conditions at the time of capturing of the image 61 may be applied in determining the food area. When these configurations are employed, the color correction marker may be omitted.

It should be noted that, in order to improve the determination accuracy of the food area, it is preferable that the color of a container for accommodating a food item or a tableware item on which a food item is placed be easy to distinguish from the food item. For example, if the food item has a color close to white, the container or tableware item may be a color similar to black or the like.

### Generation Method of Overlay Image

Next, a generation method of the overlay image will be described. As described above, the overlay area setting section 203 sets an overlay area AR1 by using the three-dimensional code OB1 as a reference. Thereafter, the overlay image generation section 205 cuts out a portion corresponding to the overlay area AR1 from the image 61, to generate a partial image. Then, the overlay image generation section 205 determines a food area in the generated partial image, and processes an image of another food item so as to conform to the shape and size of the determined food area, and then, composites the processed image on the portion corresponding to the food area. In addition, the overlay image generation section 205 makes the background area of the partial image (area outside the food area) transparent; this completes the overlay image. Here, the background area may be translucent. By making it translucent, it is possible to reflect the shade or the like of ingredients on the processed overlay image.

Here, in the image 61, the lunchbox does not front in the direction of the image 61. For this reason, the three-dimensional code OB1 is tilted in the image 61, so that the overlay area AR1 is set in a tilted fashion. More specifically, the overlay area AR1 in the image 61 is tilted to the right by an angle θ with respect to the vertical direction of the image 61.

In such a case, the display control section 206 may display, on the overlay area AR1, an image rotated by an inclination angle corresponding to the inclination angle of the overlay area AR1. Thus, even in a case where the overlay area AR1 is tilted, it is possible to achieve an example advantage of being capable of display an overlay image with good appearance, in addition to the example advantage achieved by the information processing apparatus 1 in accordance with the first example embodiment.

In a case where the rotated image is displayed on the overlay area AR1, the overlay image generation section 205 cuts out a portion corresponding to the overlay area AR1 from the image 61, and then, subjects the portion to rotation conversion (specifically, conversion by performing rotation by θ in the leftward direction), to generate the partial image 62. Next, the overlay image generation section 205 determines a food area AR2 in the partial image 62. The food area AR2 can be determined based on the color, the edge detection, or the like, as described above.

Subsequently, the overlay image generation section 205 processes an image of another food item so as to conform to the shape and size of the food area AR2, and composites the processed image on the portion corresponding to the food area AR2. The overlay image generation section 205 makes the background area AR3 of the food area AR2 in the partial image 62 transparent; this completes the overlay image. It should be noted that “make one transparent” means that the transparency is set to 100%. The overlay image may also be referred to as a mask image.

Then, the display control section 206 subjects the overlay image generated as described above to projective transformation in such a manner as to conform to the overlay area AR1 in the image 61, to thereby generate the image 63, and then, the display control section 206 composites the image 63 on the overlay area AR1 of the image 61. Accordingly, the image rotated by an inclination angle corresponding to the inclination angle of the overlay area ARI is displayed on the overlay area AR1.

### Flow of Display Control Method

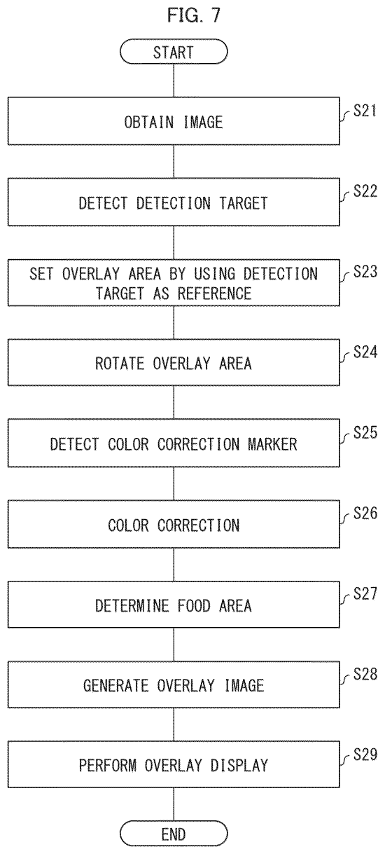

The following description will discuss the flow of a display control method carried out by the information processing apparatus 2 with reference to FIG. 7. FIG. 7 is a flowchart illustrating the flow of the display control method. In the following description, an example will be described in which, in a state where a food item is placed in front of a user who is wearing the information processing apparatus 2, an image of another food item is subjected to overlay display on an image of the food item.

In S21, the image obtaining section 201 obtains an image captured by the capturing section 22, that is, an image obtained by capturing at least part of a field of view of the user who is wearing the information processing apparatus 2. This image shows a food item the user is going to eat.

In S22, the detection section 202 detects a predetermined detection target in the image obtained in S21. Then, in S23, the overlay area setting section 203 sets, in the image obtained in S21, an overlay area for information related to the food item (specifically, an image of another food item) by using the detection target detected in S22, as a reference.

For example, in S22, it is assumed that the detection section 202 detects a three-dimensional code OB1 as illustrated in FIG. 6. In this case, in S23, the overlay area setting section 203 sets the overlay area in the position and the area indicated by the three-dimensional code OB1. As described with reference to FIG. 6, the overlay area set in this way may be tilted.

Thus, in S24, the overlay image generation section 205 cuts out a portion corresponding to the overlay area set in S23 from the image obtained in S21, and then, subjects the portion to rotation conversion, to generate a partial image with the abovementioned inclination canceled. When the overlay area set in S23 is not tilted, the process in S24 may be omitted.

In S25, the detection section 202 detects a color correction marker in the image obtained in S21. Then, in S26, the correction section 204 subjects the partial image generated in S24 to color correction by means of the color correction marker detected in S25. Here, the color correction may be performed to the image obtained in S21. Further, the processes in S25 and S26 may be performed at any timing as long as it is before S27.

In S27, the overlay image generation section 205 determines an area having a predetermined color range in the partial image undergone the color correction as a food area in which the food item is shown. Then, in S28, the overlay image generation section 205 processes an image of another food item so as to conform to the shape and size of the determined food area, and composites the processed image on the portion corresponding to the food area. In addition, the overlay image generation section 205 makes the background area of the partial image (area outside the food area) transparent; this completes the overlay image.

In S29, the display control section 206 performs overlay display of the image of the another food item on the overlay area set in S23. Specifically, the display control section 206 subjects the overlay image generated in S28 to projective transformation in such a manner as to conform to the overlay area in the image obtained in S21, and then, composites the images. This causes the user who is wearing the information processing apparatus 2 to see as if the food item placed in front of the user were the another food item. It should be noted that the processes of FIG. 7 are carried out every time the image obtaining section 201 newly obtains an image, so that the real-time overlay display can be achieved.

### Setting of Multiple Food Areas

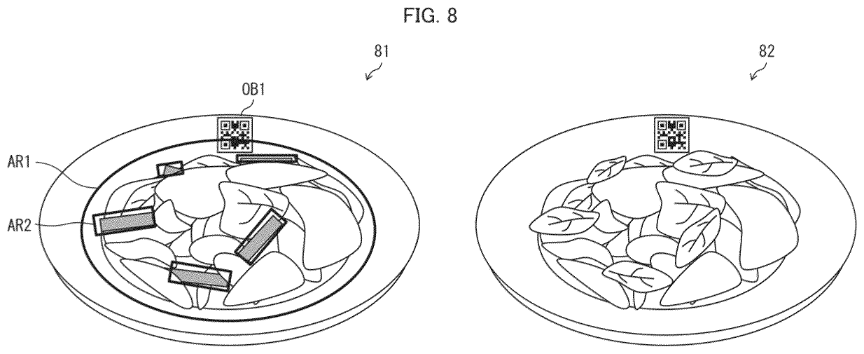

Multiple food areas may be set in the overlay area. This will be described with reference to FIG. 8. FIG. 8 is a diagram illustrating an example in which multiple food areas are set in an overlay area and overlay display is performed. FIG. 8 illustrates an image captured by the capturing section 22, that is, an image 81 obtained by capturing at least part of a field of view of the user who is wearing the information processing apparatus 2, and an image 82 obtained by performing overlay display of an image of another food item on each food area set in the image 81.

The image 81 shows a meal served on a dish. This dish is provided with a three-dimensional code OB1, and a circular overlay area AR1 inside the dish is set by using the three-dimensional code OB1 as a reference. In addition, multiple food areas AR2 are set in the overlay area AR1.

In this example, the overlay image generation section 205 sets, as the food areas AR2, rectangular areas each including an area consisting of pixels in a predetermined color range in the overlay area AR1. In this way, it is possible to set the food areas AR2, targeting some ingredient included in the food item. For example, by setting a rectangular area including an area having orange-colored pixels in the food area AR2, it is possible to set areas in which orange-colored ingredients (e.g., carrot) are shown as the food areas AR2.

Then, the overlay image generation section 205 generates an overlay image by using an image of another ingredient, and the display control section 206 performs overlay display of the overlay image on the food areas AR2. This causes the user who is wearing the information processing apparatus 2 to recognize the ingredient in the food areas AR2 as the another ingredient as illustrated in the image 82. Thus, it is possible to have the user overcome with eating an ingredient the user dislikes with prejudice, or to increase the satisfaction by making it look as if a user's favorite ingredient were included.

### Examples of Use of Hand/Tableware Item as Detection Target

The detection target detected by the detection section 202 may be a hand of the user who is wearing the information processing apparatus 2. Alternatively, the detection target detected by the detection section 202 may be a tableware item held by the user. In this case, the overlay area setting section 203 may set an overlay area by using the user's hand or the tableware item held by the user as a reference. Thus, it is possible to achieve an example advantage of being capable of displaying the overlay image on a food item the user is about to eat, in addition to the example advantage achieved by the information processing apparatus 1 in accordance with the first example embodiment.

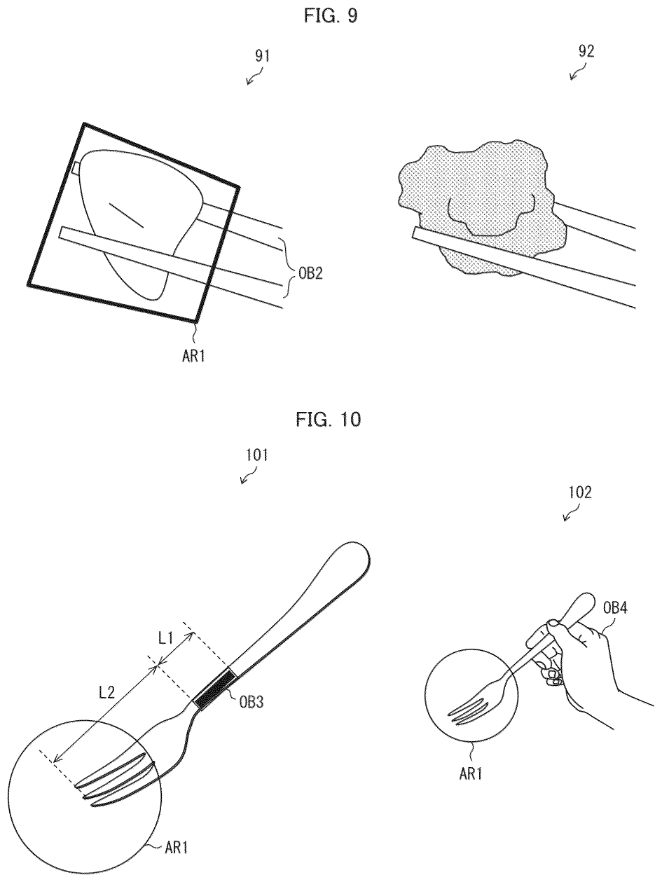

FIG. 9 is a diagram illustrating an example in which an overlay image is displayed by using chopsticks held by the user as a detection target. FIG. 9 illustrates an image captured by the capturing section 22, that is, an image 91 obtained by capturing at least part of a field of view of the user who is wearing the information processing apparatus 2, and an image 92 obtained by performing overlay display of an image of another food item on an overlay area set in the image 91.

In the example of FIG. 9, the detection section 202 detects a pair of chopsticks OB2. When chopsticks are used as a detection target, it is preferable that a user use chopsticks of a color easily distinguished from food items. Then, the overlay area setting section 203 sets a rectangular overlay area AR1 at the tip portion of the detected chopsticks OB2. In the overlay area AR1, a piece of cooked chicken breast picked up by the chopsticks OB2 is shown. It should be noted that the overlay area AR1 may have any shape and the shape is not limited to a rectangle.

Here, the overlay image generation section 205 generates an overlay image by using an image of another food item, and the display control section 206 performs overlay display of the overlay image on the overlay area AR1. This causes the user who is wearing the information processing apparatus 2 to recognize the ingredient (cooked chicken breast) shown in the overlay area AR1 as another ingredient (deep-fried chicken), as illustrated in the image 92.

FIG. 10 illustrates a setting example of an overlay area in which a fork is used as a detection target, and a setting example of an overlay area in which a user's hand holding a fork is used as a detection target. The fork illustrated in 101 of FIG. 10 has a neck portion marked with a color different from that of the remaining portion to provide a marker OB. The detection section 202 detects this marker OB3 as a detection target. In this way, it is also possible to use a portion of the tableware item as a detection target. Since the marker OB3 is positioned at the distal end of the handle section of the fork, it is also possible to detect the marker OB3 even while the fork is gripped, and since the marker OB3 is also positioned proximal to the hand compared with the tip portion of the fork, it is possible to detect the marker OB3 even with the fork stuck in a food item. The marker OB3 may be detected based on only the color, or alternatively, a combination of the color and the shape.

The length of the marker OB3 on the fork is L1, and the length of a portion of the fork that is further distal with respect to the marker OB3 is L2. The ratio of these lengths does not vary in images obtained by capturing the fork, so that the overlay area setting section 203 can determine the position at which the tip of the fork appears based on the orientation and length of the marker OB3 detected in the image and the abovementioned ratio, and can set an overlay area AR1 as illustrated in FIG. 10 by using the determined position as a reference.

Here, any code such as a three-dimensional code may be provided on the fork as a detection target. In this case, the code may include information indicating the tip position of the fork or information indicating the position and the area of the overlay area. Similarly to the example of FIG. 9, the entirety of the fork may be used as the detection target, and the overlay area AR1 may be set at the tip portion thereof. The overlay area AR1 may have any shape and the shape is not limited to a circular shape. The same applies to 102 of FIG. 10, described below.

102 of FIG. 10 illustrates a setting example of the overlay area AR1 in which a user's hand OB4 holding a fork is used as a detection target. Since the position of the hand when carrying the food item to the mouth has a predetermined positional relationship with the position of the food item, it is possible to set the overlay area AR1 on the food item by using the hand OB4 as a detection target. For example, as illustrated in 102 of FIG. 10, the overlay area setting section 203 may set the overlay area AR1 at a position on the inner side of the hand (i.e., to the left because the hand OB4 is the right hand; to the right if the hand OB4 is the left hand). It may be decided how far the overlay area ARI is set apart from the hand OB4 according to the type of used tableware items or meals.

### Variations

Any subject may carry out each process described in the above example embodiments, and is not limited to the examples described above. In other words, it is possible to construct a display control system having the same functions as those of the information processing apparatuses 1 and 2 with use of a plurality of apparatuses capable of mutual communication. For example, as for the block diagrams of FIGS. 1 and 4, a display control system having the same functions as those of the information processing apparatuses 1 and 2 can be constructed by dispersedly providing, in a plurality of apparatuses, respective blocks illustrated in FIGS. 1 and 4.

For example, among the blocks of the information processing apparatus 2 illustrated in FIG. 4, blocks from the image obtaining section 201 to the overlay image generation section 205 included in the control section 20 may be provided in a server. In this case, the information processing apparatus 2 transmits an image captured by the capturing section 22 to the server, receives, from the server, an image obtained by overlaying information on the transmitted image, and displays the received image. Such a display control system may cause a single server to carry out display control of a plurality of the information processing apparatuses 2.

### Software Implementation Example

Some or all of the functions of the information processing apparatuses 1 and 2 may be implemented by hardware such as an integrated circuit (IC chip), or may be alternatively implemented by software.

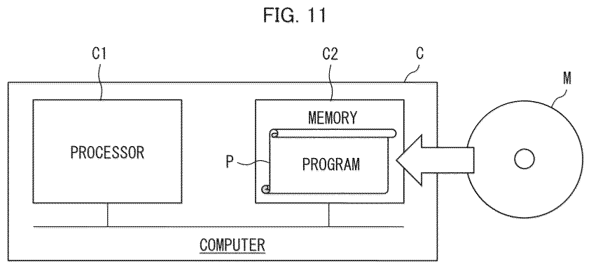

In the latter case, each of the information processing apparatuses 1 and 2 is implemented by, for example, a computer that executes instructions of a program that is software implementing the foregoing functions. FIG. 11 illustrates an example of such a computer (hereinafter, referred to as “computer C”). The computer C includes at least one processor C1 and at least one memory C2. The memory C2 stores a program (display control program) P for causing the computer C to operate as the information processing apparatus 1 or 2. The processor C1 of the computer C retrieves the program P from the memory C2 and executes the program P, so that the functions of the information processing apparatus 1 or 2 are implemented.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when the program P is executed and/or in which various kinds of data are temporarily stored. The computer C may further include a communication interface for transmitting and receiving data to and from another apparatus. The computer C may further include an input/output interface for connecting input/output apparatuses such as a keyboard, a mouse, a display and/or a printer.

The program P can be stored in a non-transitory tangible storage medium M that is readable by the computer C. Such a storage medium M may be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some of or all of the foregoing example embodiments can also be described as below. Note, however, that the present invention is not limited to the following example aspects.

### Supplementary Note 1

An information processing apparatus including: detection means for detecting a predetermined detection target in an image that is obtained by capturing at least part of a field of view of a user and shows a food item; overlay area setting means for setting, in the image, an overlay area for information related to the food item by using the detection target as a reference; and display control means for performing overlay display of the information on the overlay area.

### Supplementary Note 2

The information processing apparatus according to Supplementary note 1, wherein the display control means performs overlay display of an image of a predetermined food item on the overlay area.

### Supplementary Note 3

The information processing apparatus according to Supplementary note 2, further including correction means for subjecting the image to color correction by means of a color correction marker detected in the image, the color correction marker serving as a reference of the color correction,
wherein the display control means performs the overlay display of the image of the predetermined food item on an area with a predetermined color range in the overlay area undergone the color correction.

### Supplementary Note 4

The information processing apparatus according to any one of Supplementary notes 1 to 3, wherein the detection target is a hand of the user or a tableware item held by the user, and the overlay area setting means sets the overlay area by using the hand of the user or the tableware item held by the user as a reference.

### Supplementary Note 5

The information processing apparatus according to any one of Supplementary notes 1 to 4, wherein the detection target is a code provided on an item having a predetermined positional relationship with the food item, the code indicating a position and an area of the food item, and the overlay area setting means sets the overlay area based on the position and the area indicated by the code.

### Supplementary Note 6

The information processing apparatus according to Supplementary note 5, wherein the display control means displays, on the overlap area, an image rotated by an inclination angle corresponding to an inclination angle of the overlay area.

### Supplementary Note 7

A display control method including: detecting, by at least one processor, a predetermined detection target in an image that is obtained by capturing at least part of a field of view of a user and shows a food item; setting, by the at least one processor, in the image, an overlay area for information related to the food item by using the detection target as a reference; and performing, by the at least one processor, overlay display of the information on the overlay area.

### Supplementary Note 8

A display control program causing a computer to function as: detection means for detecting a predetermined detection target in an image that is obtained by capturing at least part of a field of view of a user and shows a food item; overlay area setting means for setting, in the image, an overlay area for information related to the food item by using the detection target as a reference; and display control means for performing overlay display of the information on the overlay area.

### Additional Remark 3

Furthermore, some of or all of the foregoing example embodiments can also be described as below.

An information processing apparatus including at least one processor, the at least one processor carrying out: a detection process of detecting a predetermined detection target in an image that is obtained by capturing at least part of a field of view of a user and shows a food item; an overlay area setting process of setting, in the image, an overlay area for information related to the food item by using the detection target as a reference; and a display control process of performing overlay display of the information on the overlay area.

Note that the information processing apparatus may further include a memory, which may store therein a program for causing the at least one processor to carry out the detection process, the overlay area setting process, and the display control process. The program may be stored in a computer-readable non-transitory tangible storage medium.

### REFERENCE SIGNS LIST

1, 2 Information processing apparatus
11, 202 Detection section
12, 203 Overlay area setting section
204 Correction section
13, 206 Display control section
OB1 Three-dimensional code (code, detection target)
OB2 Chopsticks (detection target)
OB3 Marker (detection target)
OB4 Hand (detection target)
M1 Color correction marker

What is claimed is:

1. An information processing apparatus comprising at least one processor, the processor carrying out:
a detection process of detecting a predetermined detection target in an image that is obtained by capturing at least part of a field of view of a user and shows a food item;
an overlay area setting process of setting, in the image, an overlay area for information related to the food item by using the detection target as a reference; and
a display control process of performing overlay display of the information on the overlay area.

2. The information processing apparatus according to claim 1, wherein the display control process performs overlay display of an image of a predetermined food item on the overlay area.

3. The information processing apparatus according to claim 2, the processor carrying out a correction process of subjecting the image to color correction by means of a color correction marker detected in the image, the color correction marker serving as a reference of the color correction,
wherein the display control process performs the overlay display of the image of the predetermined food item on an area with a predetermined color range in the overlay area undergone the color correction.

4. The information processing apparatus according to claim 1, wherein
the detection target is a hand of the user or a tableware item held by the user, and
the overlay area setting process sets the overlay area by using the hand of the user or the tableware item held by the user as a reference.

5. The information processing apparatus according to claim 1, wherein
the detection target is a code provided on an item having a predetermined positional relationship with the food item, the code indicating a position and an area of the food item, and
the overlay area setting process sets the overlay area based on the position and the area indicated by the code.

6. The information processing apparatus according to claim 5, wherein the display control process displays, on the overlap area, an image rotated by an inclination angle corresponding to an inclination angle of the overlay area.

7. A display control method comprising:
detecting, by at least one processor, a predetermined detection target in an image that is obtained by capturing at least part of a field of view of a user and shows a food item;
setting, by the at least one processor, in the image, an overlay area for information related to the food item by using the detection target as a reference; and
performing, by the at least one processor, overlay display of the information on the overlay area.

8. A non-transitory storage medium storing a display control program causing a computer to carry out:
a detection process of detecting a predetermined detection target in an image that is obtained by capturing at least part of a field of view of a user and shows a food item;
an overlay area setting process of setting, in the image, an overlay area for information related to the food item by using the detection target as a reference; and
a display control process of performing overlay display of the information on the overlay area.
